(19) United States
(12) Patent Application Publication
(10) Pub. No.: US 2016/0292376 A1
(43) Pub. Date: Oct. 6, 2016

(54) METHOD FOR CALIBRATING MEDICAL DISPLAY DEVICE USING SMARTPHONE

(71) Applicant: ADVAN Int'l Corp., Fremont, CA (US)

(72) Inventor: Kenzo SUDO, San Jose, CA (US)

(21) Appl. No.: 14/677,929

(22) Filed: Apr. 2, 2015

(51) Int. Cl. G06F 19/00; G06T 7/40; G09G 5/02

(52) U.S. Cl. CPC G06F 19/3412; G09G 5/02; G06T 7/408; G06T 2207/10024; G06T 2207/30121; G06T 2207/30168; G09G 2320/0693; G09G 2320/0666; G09G 2354/00; G09G 2370/06

(57) ABSTRACT

A calibration method using a body in which an image information program for displaying medical image information is installed, a medical display device connected to the body and including an image processor and a display panel, and a smartphone having a camera and enabling an application to be installed, includes a calibration preparation step of installing a calibration application in the smartphone and connecting the smartphone to the medical display device; a calibration measurement step of executing the calibration application, acquiring a measuring image displayed on the display panel using the camera of the smartphone as a color sensor, and generating calibration information from a deviation between an measured value of the acquired image and a criterion value; and a calibration performing step of transferring the calibration information generated in the calibration measurement step to the image processor of the medical display device and performing calibration.

### BACKGROUND OF THE INVENTION

The present invention disclosed herein relates to a method for calibrating a medical display device, and more particularly, to a method for calibrating a medical display device using a smartphone.

A medical display is used to diagnose a patient's condition. In order to give an accurate diagnosis, it is very important for a display device to accurately display image information.

Thus, for a medical display device, calibration is very important to enable image information to be displayed accurately.

The related art includes Korean Patent No. 10-078366 (entitled “Repair Method for Calibrating Color Display Panel, Display Device using the same, and Related Manufacturing Method,” and registered on Dec. 3, 2007).

### SUMMARY OF THE INVENTION

An object of the present invention is to provide a method for easily calibrating a medical display device using a smartphone having a camera.

Another object of the present invention is to provide a method for easily calibrating a medical display device using an inspection pod and a smartphone.

According to an embodiment of the present invention, there is provided a calibration method of a medical display device, using a body in which an image information program for displaying medical image information is installed, a medical display device connected to the body and including an image processor and a display panel, and a smartphone having a camera and enabling an application to be installed, the calibration method including: a calibration preparation step of installing a calibration application in the smartphone and connecting the smartphone to the medical display device; a calibration measurement step of executing the calibration application, acquiring a measuring image displayed on the display panel using the camera of the smartphone as a color sensor, and generating calibration information from a deviation between an measured value of the acquired image and a criterion value; and a calibration performing step of transferring the calibration information generated in the calibration measurement step to the image processor of the medical display device and performing calibration. Here the calibration measurement step includes dividing the measuring image displayed on the display panel into a plurality of areas and displaying the plurality of areas with different colors, and allowing the calibration application to output a voice message or display a text message to indicate movement of the smartphone to a specific area.

The calibration preparation step may include connecting the smartphone to a USB port of the medical display device in a wired way.

The calibration preparation step may include connecting the smartphone to a USB port of the body in a wired way and driving the image information program. The calibration preparation step may include connecting the smartphone to the body through near field wireless communication and driving the image information program.

The calibration measurement step may include bringing the camera of the smartphone into close contact with the medical display device with the camera facing the medical display device.

The calibration measurement step may be selectively or sequentially performed with respect to red, green, blue, yellow, cyan, magenta, and white.

The calibration measurement step may include: transmitting a measuring image signal to the image processor of the medical display device from the calibration application, and calculating a correction value by comparing the signal acquired by the camera with a criterion value. The calibration measurement step may further include: transferring the calculated correction value to the image processor to cause the image processor to display a corrected measuring image signal in the medical display device; and repeatedly calculating a correction value until the signal acquired by the camera matches the criterion value.

According to another embodiment of the present invention, there is provided A calibration method using a body in which an image information program for displaying medical image information is installed, a medical display device connected to the body and including an image processor and a display panel, a smartphone enabling an application to be installed, and an inspection pod connected to the smartphone, the calibration method including: a calibration preparation step of installing a calibration application in the smartphone and connecting the smartphone with the inspection pod; a calibration measurement step of executing the image information program, displaying a measuring image in the medical display device, executing the calibration application, acquiring the measuring image displayed in the medical display device using the inspection pod, acquiring calibration information from a deviation between an measured value of the acquired image and a criterion value, and generating a calibration file in the smartphone; and a calibration file transmission step of connecting the smartphone to the medical display device and transmitting the calibration file to the image processor. Here, the calibration measurement step includes: executing the image information program of the body and displaying the measuring image in the medical display device, driving the calibration application of the smartphone and acquiring a measured value from the measuring image displayed in the medical display device using the inspection pod, and dividing the measuring image into a plurality of areas and displaying the divided measuring images of red, green, blue, and white in the plurality of areas, and allowing the calibration application of the smartphone to output a voice message or display a text message to indicate movement of the inspection pod to a specific area of the measuring image through the smartphone while the inspection pod is moved to each of the areas.

The calibration preparation step may include connecting the smartphone to the inspection pod in a wired or wireless way.

The calibration file transmission step may include connecting the smartphone to a USB port provided in the medical display device in a wired way and transmitting the calibration file generated in the smartphone to the image processor.

The calibration file transmission step may include: connecting the smartphone to the body through a USB port in a wired way or through near field wireless communication, and transmitting the calibration file generated in the smartphone to the image processor of the medical display device using the image information program of the body.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a configuration of a device for performing a method for calibrating a medical display device using a smartphone according to a first embodiment of the present invention;

FIG. 2 is a flowchart for describing the method for calibrating the medical display device using the smartphone according to the first embodiment of the present invention;

FIG. 3 is a block diagram illustrating a configuration of a device for performing a method for calibrating a medical display device using a smartphone and a inspection pod according to a second embodiment of the present invention; and

FIG. 4 is a flowchart for describing the method for calibrating the medical display device using the smartphone and the inspection pod according to the second embodiment of the present invention.

### DETAILED DESCRIPTION OF PREFERRED EMBODIMENTS

The terms or words used in the specification and claims should not be construed as being limited to typical or dictionary meanings, but construed as the meaning and concept corresponding to the technical idea of the present invention on the basis of the principle that an inventor can appropriately define the concept of the term for describing his or her invention in the best method.

Accordingly, the configurations illustrated in embodiments and drawings described in the specification do not represent the technical idea of the present invention but are just exemplary embodiments. Thus, it should be understood that various equivalents and modifications may exist which can be replaced at a time when this specification was applied.

Hereinafter, a method for calibrating a medical display device using a smartphone according to a first embodiment of the present invention will be described in detail with reference to the drawings.

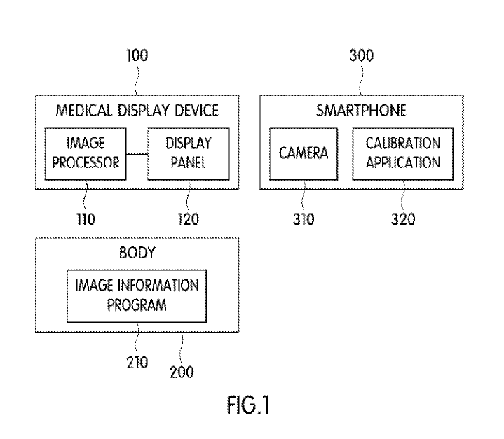

FIG. 1 is a block diagram illustrating a configuration of a device for performing a method for calibrating a medical display device using a smartphone according to a first embodiment of the present invention.

As illustrated in FIG. 1, a medical display device 100 is connected to a body 200 in which an image information program 210 for displaying medical image information is installed.

Here, the medical display device 100 may be a stand-alone medical display device or a monitor mounted in a notebook computer.

Likewise, the body 200 may be a personal computer (PC) body or a notebook body.

The body 200 has the image information program 210 for displaying medical image information installed therein.

In addition, the medical display device 100 includes a display panel 120 having an individual display pixel controlled by a driving signal and an image processor 110 which generates a driving signal for a panel based on an input image signal.

The image processor 110 performs various control functions such as interpolation, gamma correction, color correction, and another adjustment. Further, such calibration information is stored in the image processor 110.

A smartphone 300 includes a built-in camera 310 and an embedded operating system (OS) installed therein. Further, an application may be installed in the smartphone 300. A method for calibrating the medical display device 100 by installing a calibration application 320 in the smartphone 300 and using the smartphone 300 is provided. The calibration application 320 is connected to the body 200 or the medical display device 100 to control the body 200 or the medical display device 100 and transfers a calibration corrected value.

In particular, the calibration application 320 detects an output value of an image displayed in the medical display device 100 using the built-in camera 310 of the smartphone 300 as a color sensor.

The smartphone 300 may be directly connected to the medical display device via a universal serial bus (USB) in a wired way and may be connected to the body via near field wireless communication such as a USB or Bluetooth.

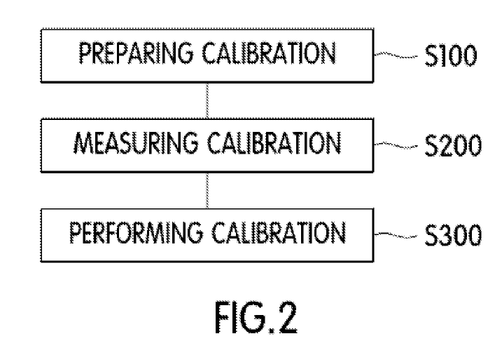

FIG. 2 is a flowchart for describing the method for calibrating the medical display device using the smartphone according to the first embodiment of the present invention.

As illustrated in FIG. 2, the method for calibrating the medical display device using the smartphone according to the first embodiment of the present invention includes preparing calibration (S100), measuring the calibration (S200), and performing the calibration (S300).

The preparing of the calibration (S100) includes installing the calibration application 320 in the smartphone 300 and connecting the smartphone 300 and the medical display device 100.

In a case in which a USB port connected to the image processor 110 is provided in the medical display device 100, the smartphone 300 may be directly connected to the medical display device 100 using the USB port.

In a case in which the USB port connected to the image processor 110 is not provided in the medical display device 100, the smartphone 300 may be connected to the medical display device 100 via the body by connecting the body 200 and the smartphone 300.

The smartphone 300 and the body 200 may be connected to each other using a USB in a wired way and may be connected to each other via near field wireless communication means such as Bluetooth.

In a case in which the smartphone 300 is connected to the medical display device 100 via the body 200, it is preferable that the smartphone 300 is connected to the body 200, and the body 200 executes the image information program 210. This is to enable the calibration application 320 of the smartphone 300 to be connected to the medical display device 100 using the image information program 210 and to perform the calibration.

When the smartphone 300 is connected to the medical display device 100, the measuring of the calibration (S200) is performed.

The measuring of the calibration (S200) includes executing the calibration application 320 installed in the smartphone 300, acquiring, by the camera 310 of the smartphone 300, a measuring image displayed in the medical display device 100 using the camera 310 of the smartphone 300 as a color sensor, and generating calibration information from a deviation of a color value of the acquired image and a color value of the measuring image.

The measuring of the calibration (S200) is performed while the camera 310 of the smartphone 300 faces the medical display device 100 and is brought into close contact with the medical display device 100.

The measuring of the calibration (S200) may be selectively or sequentially performed with respect to red, green, blue, yellow, cyan, magenta, and white and may be performed with respect to a contrast value or brightness.

The calibration is performed while a series of measuring images generated by input signals according to values R, G, B, Y, C, M, and W is displayed. A specific area of a screen is measured by the camera 310 of the smartphone 300 with respect to each of the input signals. The measured results are converted into output values R, G, B, Y, C, M, and W. There is a deviation between the output values R, G, B, Y, C, M, and W and values displayed by input values R, G, B, Y, C, M, and W due to a variety of factors. Data of the input values R, G, B, Y, C, M, and W and the output values R, G, B, Y, C, M, and W corresponding thereto is processed to generate a lookup table. The lookup table converts the input image signals to drive a signal for a panel, thus displaying an accurate light signal level.

The measuring image signal is transmitted to the image processor 110 of the medical display device 100 from the calibration application 320, and a display value of the measuring image signal is acquired from a screen on the display panel 120 through the camera 310 of the smartphone 300. Then, the display value is compared with a criterion value of the measuring image signal, and a correction value is calculated.

In this case, for the measuring image signal, a single color may be displayed on the entire display panel 120, and the display panel 120 may be divided into a plurality of areas, which may be displayed with different colors. When a measuring image signal is displayed by dividing the display panel 120 into a plurality of areas and displaying the areas with different colors, the calibration may be measured while the smartphone 300 is moved to each of the areas. Here, the calibration application 320 of the smartphone 300 may be configured to output a voice message or display a text message to indicate movement of the smartphone to the specific area.

When the calibration application 320 transfers the correction value to the image processor 110, the image processor 110 transmits the measuring image signal corrected using the correction value to the display panel 120 of the medical display device 100, and the camera compares the display value of the image signal with the criterion value to repeatedly measure whether the values match each other, thus deriving a correction value such that the criterion value and the display value match each other.

The performing of the calibration (S300) includes transferring the correction value derived in the measuring of the calibration (S200) to the image processor 110 and storing the correction value in the image processor 110 to complete the calibration.

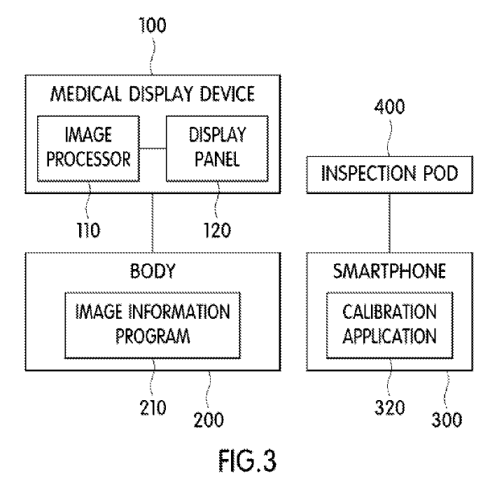

FIG. 3 is a block diagram illustrating a configuration of a device for performing a method for calibrating a medical display device using a smartphone and an inspection pod according to a second embodiment of the present invention.

As illustrated in FIG. 3, the medical display device 100 is connected to the body 200 having the image information program 210 for displaying the medical image information installed therein.

Here, the medical display device 100 may be a stand-alone medical display device or a monitor mounted in a notebook computer.

Likewise, the body 200 may be a PC body or a notebook body.

The body 200 has the image information program 210 for displaying the medical image information installed therein.

In addition, the medical display device 100 includes a display panel 120 having an individual display pixel controlled by a driving signal and an image processor 110 which generates a driving signal for a panel based on an input image signal.

The image processor 110 performs various control functions such as interpolation, gamma correction, color correction, and another adjustment. Further, such calibration information is stored in the image processor 110.

The smartphone 300 has an OS installed therein. Further, an application may be installed in the smartphone 300. The smartphone 300 may be connected to an inspection pod 400 in a wireless or wired way. The present invention provides a method for calibrating the medical display device 100. Here, the method includes installing the calibration application 320 in the smartphone 300, connecting the inspection pod 400 to the smartphone 300, generating a calibration file in the smartphone 300, and transferring the generated calibration file.

The calibration application 320 generates a calibration file from a value measured through the inspection pod 400 and transfers the generated calibration file to the medical display device 100 directly or via the body 200.

The inspection pod 400 includes a sensor such as a colorimeter, a luminance meter, a photo spectrometer, and is connected to the smartphone 300 in a wired or wireless way and transfers the measured value to the calibration application 320 installed in the smartphone 300.

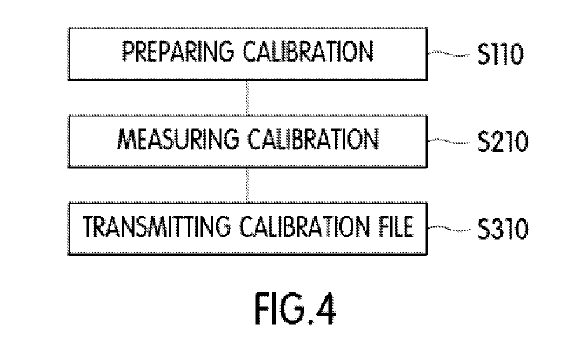

FIG. 4 is a flowchart for describing the method for calibrating the medical display device using the smartphone and the inspection pod according to the second embodiment of the present invention.

As illustrated in FIG. 4, the method for calibrating the medical display device using the smartphone according to the embodiment of the present invention includes preparing calibration (S110), measuring the calibration (S210), and transmitting a calibration file (S310).

The preparing of the calibration (S110) includes installing the calibration application 320 in the smartphone 300 and connecting the smartphone 300 and the inspection pod 400.

The smartphone 300 and the inspection pod 400 may be directly connected to each other in a wired way and may be connected to each other through near field wireless communication such as Bluetooth.

The smartphone 300 includes one port for USB connection. Thus, when the inspection pod 400 and the smartphone 300 are connected to each other through near field wireless communication such as Bluetooth, a state in which the smartphone 300 is connected to the medical display device 100 or the body 200 via the USB port may be maintained while the smartphone 300 is connected to the inspection pod 400.

In this case, the measuring of the calibration (S210) and the transmitting of the calibration file (S310) may be almost simultaneously performed.

However, when the inspection pod 400 and the smartphone 300 are connected to each other via the USB port in a wired way, the smartphone 300 may not be connected to the body 200 or the medical display device 100 via the USB port. Thus, in this case, the smartphone 300 generates the calibration file, and the inspection pod 400 is then removed from the USB port. Next, the smartphone 300 is connected to the medical display device 100 or the body 200 via the USB port and transmits the calibration file.

When the smartphone 300 is connected to the inspection pod 400, the measuring of the calibration (S210) is performed.

The measuring of the calibration (S210) includes executing the image information program 210 installed in the body 200, displaying the measuring image in the medical display device 100, executing the calibration application 320 of the smartphone 300, acquiring the measuring image displayed in the medical display device 100 through the inspection pod 400, and acquiring calibration information from a deviation of the acquired value of the acquired image and the criterion value.

In this case, the calibration application 320 of the smartphone generates the calibration file using the calibration information.

The calibration file is generated with respect to each color value.

The measuring image has a format in which one image is divided into a plurality of areas and the plurality of areas may display the divided measuring images of red, green, blue, and white. In this case, the measured value is detected and the calibration file is generated while the inspection pod 400 is moved to each of the areas.

Here, the calibration application 320 of the smartphone 300 may output a voice message or display a text message indicating movement of the inspection pod 400 to a specific area of the measuring image through the smartphone 300.

Alternatively, the entire measuring image may sequentially display the measuring images of red, green, blue, and white. Images of each color are displayed for sufficient time required for inspection, and the next image of color is then displayed. In this case, it is not necessary to move the inspection pod 400.

The calibration is performed while a series of measuring images generated by input signals according to values R, G, B, and W is displayed. A specific area of a screen is measured by the camera 310 of the smartphone 300 with respect to each of the input signals. The measured results are converted into output values R, G, B, and W. There is a deviation between the output values R, G, B, and W and values displayed by input values R, G, B, and W due to a variety of factors. Data of the input values R, G, B, and W and the output values R, G, B, and W corresponding thereto is processed to generate a lookup table. The lookup table converts the input image signals to drive a signal for a panel, and thus an accurate light signal level is displayed.

The calibration application 320 acquires the displayed value of the measuring image signal displayed on the display panel 120 of the medical display device 100 through the inspection pod 400 connected to the smartphone 300, and then compares the displayed value and the criterion value of the measuring image signal and calculates the corrected value.

The calibration application 320 collects the corrected values of each color and generates the calibration file to be transferred to the image processor 110.

When the calibration file has been generated, the calibration application of the smartphone transmits a guidance message indicating connection of the smartphone with the body or the medical display device.

The calibration application 320 of the smartphone 300 generates the calibration file and then performs the transmitting of the calibration file (S310).

In the transmitting of the calibration file (S310), the smartphone 300 is connected to the medical display device 100 directly or through the body 200. The calibration file should be transferred to and stored in the image processor 110. When the medical display device 100 includes a USB port directly connected to the image processor 110, the smartphone 300 is connected to the USB port in a wired way, thereby directly transferring the calibration file to the image processor 110.

The calibration file may be transferred through the body 200 connected to the medical display device 100. In this case, the image information program 210 installed in the body 200 is used. The smartphone 300 and the body 200 are first connected to each other in a wired or wireless way and the calibration file is transferred to the body 200. Then, the calibration file is transferred to the image processor 110 of the medical display device 100 using the image information program 210 of the body 200.

As described above, according to the method for calibrating the medical display device using the smartphone of the present invention, as the calibration of the medical display device is performed using the camera of the smartphone as the color sensor, or the calibration of the medical display device is performed using the smartphone and the inspection pod, an effect of enabling the calibration of the medical display device using the smartphone without a separate device is obtained.

According to the present invention, an effect of enabling the camera provided for the smartphone as the color sensor for detecting the color of the monitor or the calibration of the medical display device using the inspection pod is obtained.

Therefore, an effect of easily enabling the calibration of the medical display device using the smartphone, or the smartphone and the inspection pod without a separate device is obtained.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A calibration method of a medical display device, using a body in which an image information program for displaying medical image information is installed, a medical display device connected to the body and including an image processor and a display panel, and a smartphone having a camera and enabling an application to be installed, the calibration method comprising:
a calibration preparation step of installing a calibration application in the smartphone and connecting the smartphone to the medical display device;
a calibration measurement step of executing the calibration application, acquiring a measuring image displayed on the display panel using the camera of the smartphone as a color sensor, and generating calibration information from a deviation between an measured value of the acquired image and a criterion value; and
a calibration performing step of transferring the calibration information generated in the calibration measurement step to the image processor of the medical display device to perform calibration,
wherein the calibration measurement step comprising:
dividing the measuring image displayed on the display panel into a plurality of areas and displaying the plurality of areas with different colors, and
allowing the calibration application to output a voice message or display a text message to indicate movement of the smartphone to a specific area.

2. The calibration method of claim 1, wherein the calibration preparation step comprises connecting the smartphone to a USB port of the medical display device in a wired way.

3. The calibration method of claim 1, wherein the calibration preparation step comprises connecting the smartphone to a USB port of the body in a wired way and driving the image information program.

4. The calibration method of claim 1, wherein the calibration preparation step comprises connecting the smartphone to the body through near field wireless communication and driving the image information program.

5. The calibration method of claim 1, wherein the calibration measurement step comprises bringing the camera of the smartphone into close contact with the medical display device with the camera facing the medical display device.

6. The calibration method of claim 1, wherein the calibration measurement step is selectively or sequentially performed with respect to red, green, blue, yellow, cyan, magenta, and white.

7. The calibration method of claim 1, wherein the calibration measurement step comprises:
transmitting a measuring image signal to the image processor of the medical display device from the calibration application, and
calculating a correction value by comparing the signal acquired by the camera with a criterion value.

8. The calibration method of claim 7, wherein the calibration measurement step further comprises:
transferring the calculated correction value to the image processor to cause the image processor to display a corrected measuring image signal in the medical display device; and
repeatedly calculating a correction value until the signal acquired by the camera matches the criterion value.

9. A calibration method of a medical display device, using a body in which an image information program for displaying medical image information is installed, a medical display device connected to the body and including an image processor and a display panel, a smartphone enabling an application to be installed, and an inspection pod connected to the smartphone, the calibration method comprising:
a calibration preparation step of installing a calibration application in the smartphone and connecting the smartphone with the inspection pod;
a calibration measurement step of executing the image information program, displaying a measuring image in the medical display device, executing the calibration application, acquiring the measuring image displayed in the medical display device using the inspection pod, acquiring calibration information from a deviation between an measured value of the acquired image and a criterion value, and generating a calibration file in the smartphone; and
a calibration file transmission step of connecting the smartphone to the medical display device to transmit the calibration file to the image processor,
wherein the calibration measurement step comprises:
executing the image information program of the body and displaying the measuring image in the medical display device,
driving the calibration application of the smartphone and acquiring a measured value from the measuring image displayed in the medical display device using the inspection pod, and
dividing the measuring image into a plurality of areas and displaying the divided measuring images of red, green, blue, and white in the plurality of areas, and
allowing the calibration application of the smartphone to output a voice message or display a text message to indicate movement of the inspection pod to a specific area of the measuring image through the smartphone while the inspection pod is moved to each of the areas.

10. The calibration method of claim 9, wherein the calibration preparation step comprises connecting the smartphone to the inspection pod in a wired or wireless way.

11. The calibration method of claim 9, wherein the calibration file transmission step comprises connecting the smartphone to a USB port provided in the medical display device in a wired way and transmitting the calibration file generated in the smartphone to the image processor.

12. The calibration method of claim 9, wherein the calibration file transmission step comprises:
connecting the smartphone to the body through a USB port in a wired way or through near field wireless communication, and
transmitting the calibration file generated in the smartphone to the image processor of the medical display device using the image information program of the body.
